(19) United States
(12) Patent Application Publication
(10) Pub. No.: US 2006/0242390 A1
(43) Pub. Date: Oct. 26, 2006

(54) Advanced load address table buffer

(75) Inventors: James R. Vash, Littleton, MA (US); Mark P. Miller, Amesbury, MA (US)

Correspondence Address: CAVEN & AGHEVLI;c/o PORTFOLIOIP, P.O. BOX 52050, MINNEAPOLIS, MN, 55402, US

(73) Assignee: Intel Corporation

(21) Appl. No.: 11/114,754

(22) Filed: Apr. 26, 2005

(51) Int. Cl. G06F 9/44

(52) U.S. Cl. 712/235

(57) ABSTRACT

Methods and apparatus to store information corresponding to a data speculative instruction are described. In one embodiment, an apparatus includes an advanced load address table (ALAT) buffer to store the information corresponding to the data speculative instruction.

### TECHNICAL FIELD

The present disclosure generally relates to the field of computing. More particularly, an embodiment of the invention relates to an advanced load address table (ALAT) buffer.

### BACKGROUND

Some processors utilize data speculation to improve processing performance; for example, by increasing parallelism and hiding memory latency. More specifically, data speculation is the execution of a memory load prior to a store that preceded it in program order, where the load and store addresses cannot be completely disambiguated at compile time. Data speculative loads are also referred to as “advanced loads.” Generally, a compiler may reorder the execution of certain instructions to provide improved processing performance.

Information regarding advanced loads may be stored in an ALAT. More particularly, when an advanced load instruction is executed, it may allocate an entry in the ALAT. Also, an advanced load check or check load instruction (“check instruction”) may be inserted at the original location of the load instruction to check or confirm that the entry of the advanced load instruction is still valid at the location where the original load instruction was scheduled. When a corresponding check instruction is executed to check the validity of the advanced load entry in the ALAT, the presence of the entry in the ALAT indicates that the data speculation of the advanced load has succeeded. Otherwise, the data speculation has failed and a recovery may be performed to retrieve the appropriate valid data.

In some of the current microarchitectures, the length of the pipeline between instruction execution and instruction commit (i.e., retirement) may be two to three stages. In this case, the number of instructions in this window which could modify the contents of the ALAT and affect the behavior of subsequently executing instructions is relatively small. Thus, modifications to the ALAT may be deferred until instruction commit. Even in such cases, there may still be performance degradation relating to the window between execution and commit of instructions which modify the ALAT and their effect on subsequently executing instructions.

Furthermore, to achieve higher clock frequencies, processor pipelines are generally becoming deeper. In turn, the length of the pipeline between instruction execution and instruction commit may also become longer (e.g., variable, and around eight cycles). This may provide unacceptable performance when performing data speculation.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1A-1B illustrate block diagrams of computing systems in accordance with embodiments of the invention.

FIG. 2 illustrates a block diagram of portions of a processor core, in accordance with an embodiment of the invention.

FIG. 3 illustrates a block diagram of a data speculative instruction data flow system, in accordance with an embodiment of the invention.

FIG. 4 illustrates a flow diagram of a method for storing information corresponding to a data speculative instruction, in accordance with an embodiment of the invention.

FIG. 5 illustrates a flow diagram of a method for checking stored information corresponding to a data speculative instruction, in accordance with an embodiment of the invention.

### DETAILED DESCRIPTION

In the following description, numerous specific details are set forth in order to provide a thorough understanding of various embodiments of the invention. However, it will be understood by those skilled in the art that the various embodiments of the invention may be practiced without the specific details. In other instances, well-known methods, procedures, components, and circuits have not been described in detail so as not to obscure the particular embodiments of the invention.

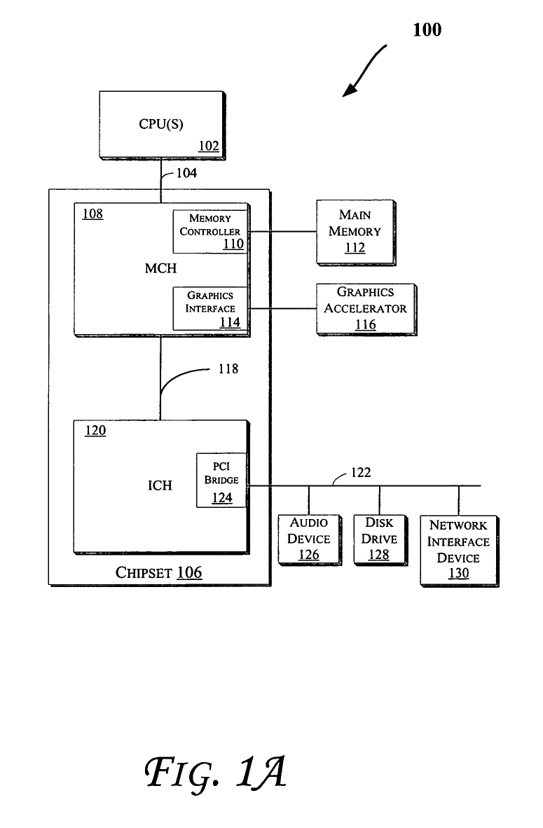

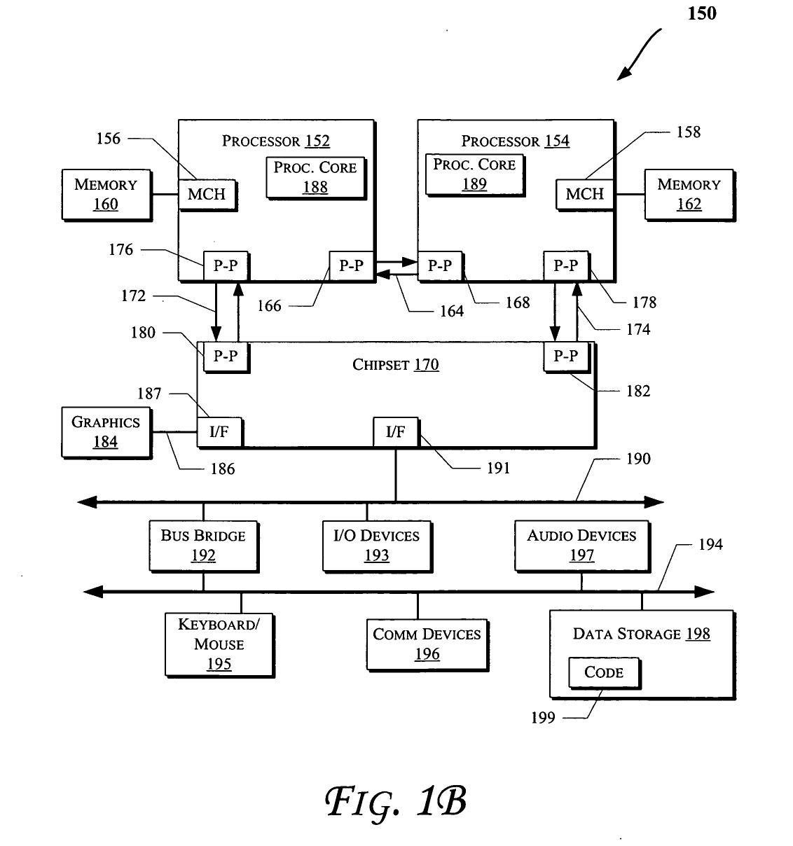

FIG. 1A illustrates a block diagram of a computing system 100 in accordance with an embodiment of the invention. The computing system 100 includes one or more central processing unit(s) (CPUs) 102 or processors coupled to an interconnection network 104. Moreover, the processors may have a single or multiple core design.

A chipset 106 may also be coupled to the interconnection network 104. The chipset 106 includes a memory control hub (MCH) 108. The MCH 108 may include a memory controller 110 that is coupled to a main system memory 112. The main system memory 112 may store data and sequences of instructions that are executed by the CPU 102, or any other device included in the computing system 100. In one embodiment of the invention, the main system memory 112 may include one or more volatile storage (or memory) devices such as random access memory (RAM), dynamic RAM (DRAM), synchronous DRAM (SDRAM), and the like. Additional devices may also be coupled to the interconnection network 104, such as multiple CPUs and/or multiple system memories.

The MCH 108 may also include a graphics interface 114 coupled to a graphics accelerator 116. In one embodiment of the invention, the graphics interface 114 may be coupled to the graphics accelerator 116 via an accelerated graphics port (AGP). In an embodiment of the invention, a display (such as a flat panel display) may be coupled to the graphics interface 114 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 118 may couple the MCH 108 to an input/output control hub (ICH) 120. The ICH 120 provides an interface to input/output (I/O) devices coupled to the computing system 100. The ICH 120 may be coupled to a peripheral component interconnect (PCI) bus 122. Hence, the ICH 120 includes a PCI bridge 124 that provides an interface to the PCI bus 122. The PCI bridge 124 provides a data path between the CPU 102 and peripheral devices. Additionally, other types of topologies may be utilized.

The PCI bus 122 may be coupled to an audio device 126, one or more disk drive(s) 128, and a network interface device 130. Other devices may be coupled to the PCI bus 122. Also, various components (such as the network interface device 130) may be coupled to the MCH 108 in some embodiments of the invention. Moreover, network communication may be established via internal and/or external network interface device(s) (130), such as a network interface card (NIC). In addition, the CPU 102 and the MCH 108 may be combined to form a single chip. Furthermore, the graphics accelerator 116 may be included within the MCH 108 in other embodiments of the invention.

Additionally, other peripherals coupled to the ICH 120 may include, in various embodiments of the invention, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like.

Hence, the computing system 100 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 128), a floppy disk, a compact disk ROM (CD-ROM), a digital versatile disk (DVD), flash memory, a magneto-optical disk, or other types of nonvolatile machine-readable media suitable for storing electronic instructions and/or data.

FIG. 1B illustrates a computing system 150 that is arranged in a point-to-point (PtP) configuration, according to an embodiment of the invention. In particular, FIG. 1B shows a system where processors, memory, and input/output devices are interconnected by a number of point-to-point interfaces.

The system 150 of FIG. 1B may also include several processors, of which only two, processors 152 and 154 are shown for clarity. Processors 152 and 154 may each include a local memory controller hub (MCH) 156 and 158 to connect with memory 160 and 162. Processors 152 and 154 may exchange data via a point-to-point (PtP) interface 164 using PtP interface circuits 166 and 168, respectively. Processors 152 and 154 may each exchange data with a chipset 170 via individual PtP interfaces 172 and 174 using point to point interface circuits 176, 178, 180, and 182. Chipset 170 may also exchange data with a high-performance graphics circuit 184 via a high-performance graphics interface 186, using a PtP interface circuit 187.

At least one embodiment of the invention may be located within the processors 152 and 154 (e.g., within the processor cores 188 and 189). Other embodiments of the invention, however, may exist in other circuits, logic units, or devices within the system of FIG. 1B. Furthermore, other embodiments of the invention may be distributed throughout several circuits, logic units, or devices illustrated in FIG. 1B.

The chipset 170 may be coupled to a bus 190 using a PtP interface circuit 191. The bus 191 may have one or more devices coupled to it such as a bus bridge 192 and I/O devices 193. Via a bus 194, the bus bridge 193 may be coupled to other devices such as a keyboard/mouse 195, communication devices 196 (such as modems, network interface devices, and the like), audio I/O device, and/or a data storage device 198. The data storage device 198 may store code 199 that may be executed by the processors 152 and/or 154.

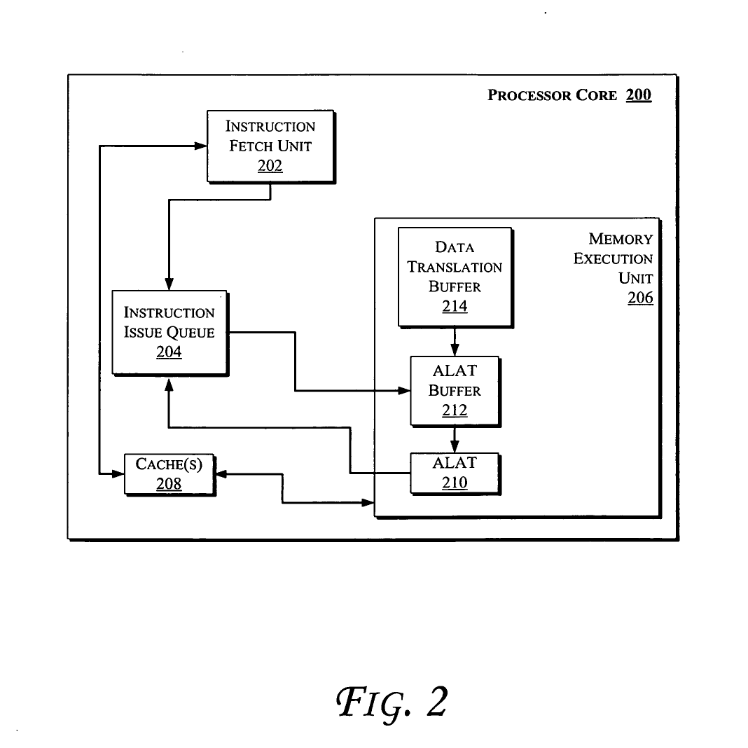

FIG. 2 illustrates a block diagram of portions of a processor core 200, in accordance with an embodiment of the invention. In one embodiment of the invention, the CPU 102 of FIG. 1A or processors 152-154 of FIG. 1B includes the processor core 200. Also, one or more processor cores (such as the processor core 200) may be implemented on a single integrated circuit chip. Moreover, the chip may include shared or private cache(s), an interconnect, memory controller, and the like.

As illustrated in FIG. 2, the processor core 200 may include an instruction fetch unit 202 to fetch instructions for execution by the core 200. The instructions may be fetched from any suitable storage devices such as the main memory 112 of FIG. 1A, disk drive 128 of FIG. 1A, memory 160-162 of FIG. 1B, remotely from a device coupled to the network interface device 130 of FIG. 1A or communication devices 196 of FIG. 1B (such as a server), and the like. The instruction fetch unit 202 may be coupled to an instruction issue queue 204 which schedules and/or issues instructions to various components of the processor core 200 for execution. For example, the instruction issue queue 204 may issue instructions to a memory execution unit 206, an integer execution unit (not shown), a floating execution unit (not shown), and the like. Also, the instruction issue queue 204 may provide various information (e.g., instruction commit status) to the memory execution unit 206, as will be further discussed with respect to the remaining figures. The memory execution unit 206 handles the execution of instructions that operate on memory.

The processor core 200 may also include one or more cache memory devices 208 (that may be shared in one embodiment of the invention) such a level 1 (L1) cache, a level 2 (L2) cache, and the like to store instructions and/or data that are utilized by one or more components of the processor core 200. Various components of the processor core 200 may be coupled to the cache(s) directly, through a bus, and/or memory controller or hub (e.g., the memory controller 110 of FIG. 1A and MCH 108 of FIG. 1A and MCH 15-158 of FIG. 1B). Also, included within the processor core 200 (and within the memory execution unit 206 in an embodiment of the invention), may be components which address the handling of the data speculation functionality. For example, a table known as an ALAT 210 may be included to store information regarding data speculative instructions. More particularly, when a data speculative instruction is executed, an entry may be allocated in the ALAT 210.

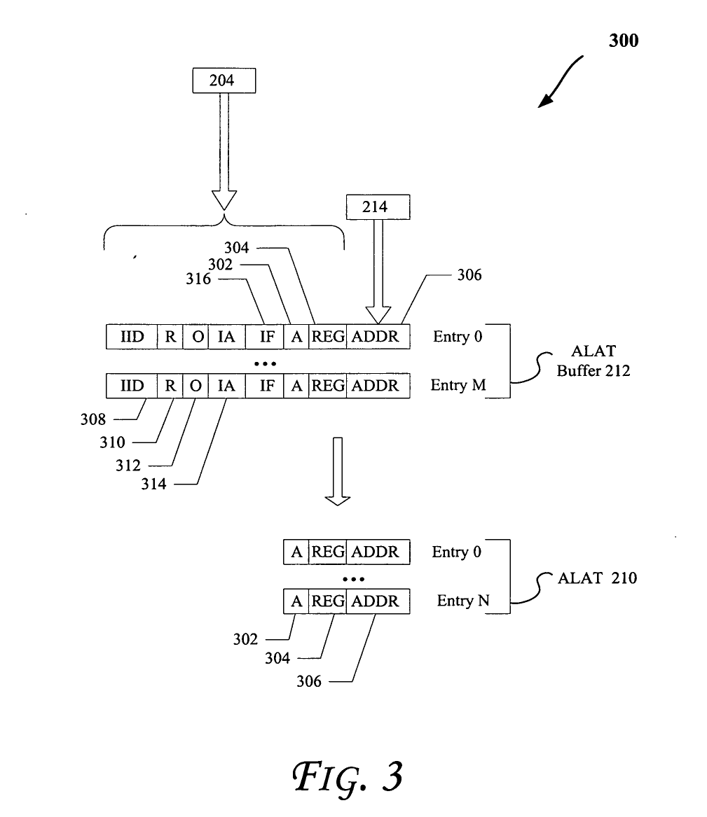

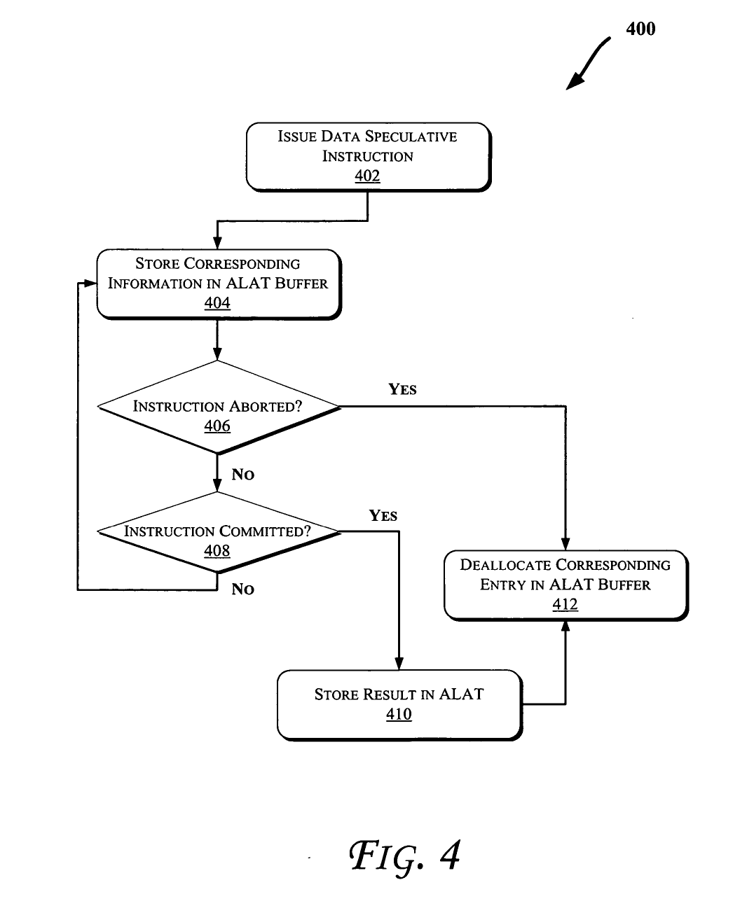

In one embodiment of the invention, the ALAT 210 is coupled to an ALAT buffer 212 to provide storage for information that is subsequently stored in the ALAT 210, as will be further discussed herein, e.g., with reference to FIGS. 3-4. As illustrated in FIG. 2, the ALAT buffer 212 may be coupled to the instruction issue queue 204 to receive various types of information regarding data speculative instructions. The ALAT buffer 212 may also be coupled to a data translation buffer 214 to receive physical address information regarding data speculative instructions. The data translation buffer 214 may store information about virtual to physical address translations, e.g., within its own structure. The data translation buffer 214 may receive the virtual address from the integer execution unit. In an embodiment of the invention, the ALAT buffer 212 and ALAT 210 are part of the memory execution unit 206 which may execute one memory instruction per cycle. The executed instruction may be a data speculation instruction that would involve the ALAT 210 and ALAT buffer 212. Further details regarding information stored in the ALAT buffer 212 is discussed with reference to FIG. 3.

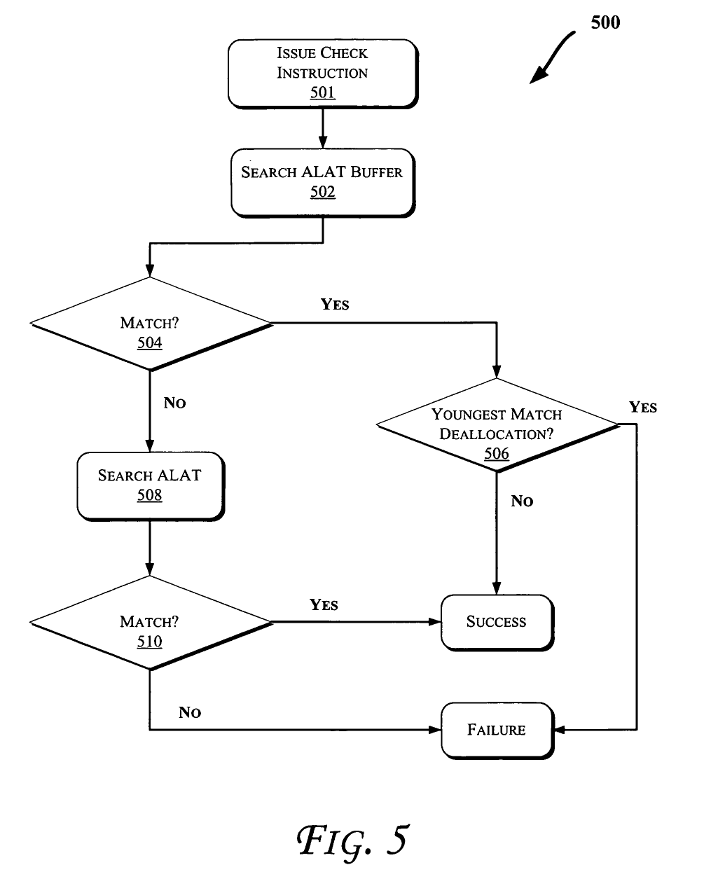

As illustrated in FIG. 2, the ALAT buffer 212 may be coupled to the instruction issue queue 204. The output of the ALAT buffer 212 may include success or failure indication for a check instruction (such as discussed with reference to FIG. 5). Hence, an indication regarding the result of a check instruction may be provided to the instruction issue queue 204 to assist in subsequent scheduling and/or issuing of instructions. Generally, a check instruction may be inserted at the original location of the load instruction to check or confirm that the entry of the advanced load instruction is still valid. When a check instruction is executed to check the validity of the advanced load entry, e.g., in the ALAT 210 and/or ALAT buffer 212, the presence of the entry indicates that the data speculation of the advanced load has succeeded. Otherwise, the data speculation has failed and a recovery may be performed to retrieve the appropriate valid data.

FIG. 3 illustrates a block diagram of a data speculative instruction data flow system 300, in accordance with an embodiment of the invention. In one embodiment of the invention, the system 300 illustrates data flow to/from an ALAT and ALAT buffer (e.g., the ALAT 210 and ALAT buffer 212 of FIG. 2, respectively). As illustrated in FIG. 3, the ALAT 210 may include one or more entries. Each entry of the ALAT 210 may include various fields such as an allocate field (A) 302 (e.g., to indicate whether the respective entry corresponds to an allocation or deallocation event), a physical register identifier (REG) 304 (e.g., for searching various entries of the ALAT 210 for a given register identifier, such as discussed with reference to FIG. 5), and a physical address (ADDR) 306 (e.g., to store the physical address of a data speculative instruction). The allocate field 302 may be one bit wide, where a set bit indicates an allocation event and a clear bit indicates a deallocation event for that entry. The register identifier 304 and/or physical address 306 may have any suitable length, such as 8 bits, 16 bits, 32 bits, 64 bits, 128 bits, 256 bits, and the like.

The ALAT buffer 212 may also include one or more entries. In one embodiment of the invention, the number of entries of the ALAT 210 and ALAT buffer 212 may be different. In an embodiment of the invention, the ALAT buffer 212 may have more storage space than the ALAT 210 to store multiple entries corresponding to a single physical register identifier. Each entry of the ALAT buffer 212 may include various fields such as the allocate field 302, the physical register identifier 304, and the physical address 306, such as those discussed with reference to the ALAT 210. The ALAT buffer 212 may additionally include other entries such as an instruction identifier (IID) 308 (e.g., to indicate an age order of the given entry), a retired field (R) 310 (e.g., to indicate whether the given entry is retired), an occupied field (O) 312 (e.g., to indicate whether the given entry is occupied with valid information), an invalidate all field (IA) 314 (e.g., to indicate that a deallocation event may apply to all entries in the ALAT 210 (and ALAT buffer 212); hence, any subsequent check instructions would fail), and/or an invalidate frame field (IF) 316 (e.g., to indicate that a deallocation event may apply to all entries within a given frame; hence, any subsequent check instructions directed to this frame would fail).

The instruction identifier 308 may have any suitable length, such as 8 bits, 16 bits, 32 bits, 64 bits, 128 bits, 256 bits, and the like to uniquely identify the age of the given entry. The retired field 310 may be one bit wide, where a set bit indicates a retired (committed) entry and a clear bit indicates an aborted (e.g., killed or not committed) entry. The occupied field 312 may also be one bit wide, where a set bit indicates an occupied entry and a clear bit indicates an unoccupied entry. Similarly, the invalidate all (314) and invalidate frame (316) fields may be one bit wide to indicate the appropriate invalidation range when set and otherwise when clear. Hence, the ALAT buffer (212) may include multiple entries for the same physical register identifier (304), and it may include information about both ALAT (210) allocation and deallocation events (302). The ALAT buffer (212) may also include some additional state information (e.g., field 314) to allow for deallocation events which affect the entire ALAT (210), or all entries within a range of physical register identifiers (e.g., field 316). The ALAT buffer (212) may also store information about the age (e.g., field 308) and commit status (e.g., field 310) of the corresponding data speculative instruction.

As illustrated in FIG. 3 and discussed with reference to FIG. 2, the ALAT buffer 212 (and in one embodiment of the invention, the physical address 306) may receive input from the data translation buffer 214 of FIG. 2. The data translation buffer (214 of FIG. 2) may provide the address field 306 at the time of allocation in the ALAT buffer 212 of the data speculative instruction. Input information for the other fields within the ALAT buffer 212 (such as fields 302, 304, and/or 308-316) may be provided by the instruction issue queue 204 of FIG. 2. As is further discussed herein, e.g., with respect to FIG. 4, some of the information stored in the ALAT buffer 212 may be provided to their corresponding fields (e.g., 302, 304, and/or 306) in the ALAT 210 once a data speculative instruction is committed (for example, as indicated by the retired field 310 of the ALAT buffer 212).

FIG. 4 illustrates a flow diagram of a method 400 for storing information corresponding to a data speculative instruction, in accordance with an embodiment of the invention. The data speculative instruction may be capable of modifying an ALAT (such as the ALAT 210 of FIG. 2). The data speculative instruction may perform one or more tasks such as an advanced load, a check load, and an ALAT invalidation, such as “ld.a,” “ld.c,” and “invala” instructions, respectively, in accordance with at least one instruction set architecture. Additionally, the data speculative instruction may be scheduled by a compiler.

The method 400 issues a data speculative instruction (402), for example when the instruction issue queue 204 of FIG. 2 sends a data speculative instruction to the memory execution unit 206 of FIG. 2. Prior to the data speculative instruction being committed (408) (e.g., as indicated by the retired field 310 of the ALAT buffer 212 in FIG. 3), information corresponding to the uncommitted data speculative instruction is stored in the ALAT buffer (404), such as discussed with reference to the ALAT buffer 212 of FIGS. 2 and 3. Moreover, as discussed with respect to various fields of the ALAT buffer 212 of FIG. 3, the ALAT buffer 212 may receive a physical address 306 from the data translation buffer 214 of FIG. 2.

The ALAT buffer 212 may also receive other information from the instruction issue queue 204 regarding ALAT invalidation (e.g., field 314 of FIG. 3), instructions which may change a register stack engine bottom of frame (e.g., field 316 of FIG. 3), as such information may be capable of modifying the interpretation of the physical register identifier (e.g., field 306 of FIG. 3) that corresponds to the data speculative instruction. Hence, information stored in the stage 404 may include one or more items in an entry of the ALAT buffer 212, such as an allocate field (302), a physical register identifier (304), a physical address (306), an instruction identifier (308), a retired field (310), an occupied field (312), an invalidate all field (314), and an invalidate frame field (316). These entries may potentially correspond to the same physical register identifier such as discussed with reference to FIGS. 2 and 3.

Once the data speculative instruction is committed (408) (e.g., as indicated by the retired field 310 of the ALAT buffer 212 in FIG. 3), the information corresponding to the data speculative instruction is stored (410) in the ALAT (such as the ALAT 210 of FIGS. 2-3). Accordingly, in one embodiment of the invention, the data corresponding to the uncommitted data speculative instruction is stored in the ALAT buffer 212 prior to storing the data in the ALAT 210. The entry corresponding to the data speculative instruction may be deallocated or removed (412) from the ALAT buffer (212) after the data speculative instruction is committed. This entry of the ALAT buffer (212) may then be utilized to store information corresponding to subsequent data speculative instructions. Hence, the result(s) of the data speculative instruction may be moved from the ALAT buffer (212) to the ALAT (210).

In one embodiment of the invention, information corresponding to an in-flight data speculative instruction is stored (404) in an ALAT buffer (212) prior to the data speculative instruction being committed (408). Generally, an in-flight instruction is an instruction between execution (402) and commit (408) stages, e.g., as determined by an instruction issue queue (204 of FIG. 2).

In an embodiment of the invention, the ALAT 210 and ALAT buffer 212 store memory addresses (e.g., 306), and not the actual memory data. One or more caches (e.g., 208 of FIG. 2), e.g., inside and/or outside of the memory execution unit (206) and/or the processor core 200, may deal with the actual data.

If the execution of the data speculative instruction is aborted (406), e.g., if the instruction is aborted, killed, or otherwise not committed due to, for example, faults, branch mispredicts, or other interruptions, one or more corresponding entries in the ALAT buffer (212) may be deallocated (412), or otherwise utilized to unwind the aborted data speculative instruction. In one embodiment of the invention, one or more entries that correspond to a younger data speculative instruction may also be deallocated (412). This allows for deallocation of the affected entries (and potential reversal of their side effects) more efficiently, in one embodiment of the invention. Also, the ALAT buffer (212) may provide for an ALAT (210) that is up-to-date with respect to prior instructions even if those instructions are not yet committed. Accordingly, the ALAT buffer (212) may buffer the side effects of executing data speculative instructions until their commit state is known (e.g., as indicated by the retired field 310 of the ALAT buffer 212 in FIG. 3). In an embodiment of the invention, this allows for retaining an up-to-date ALAT (210) in a relatively deep pipeline without corrupting the ALAT (210) state. Additionally, even though in FIG. 4, the stage 406 is indicated as being performed prior to the stage 408, the stage 406 (namely, determination of whether the data speculative instruction is aborted) may be performed at any time or independent of other tasks.

FIG. 5 illustrates a flow diagram of a method 500 for checking stored information corresponding to a data speculative instruction, in accordance with an embodiment of the invention. In one embodiment of the invention, the method 500 may be utilized to check stored information corresponding to the data speculative instruction discussed with reference to FIG. 4. For example, a check instruction may be scheduled a number of cycles after the data speculative instruction (e.g., by the instruction issue queue 204 of FIG. 2).

As illustrated in FIG. 5, check instructions (such as “ld.c” and “chk.a” instructions, in accordance with at least one instruction set architecture) which are directed at checking the ALAT (210) for a particular physical register identifier (304) may search the ALAT buffer 212 in conjunction with the ALAT 210, in order to account for in-flight (uncommitted) instructions which may modify the ALAT 210. As discussed with reference to FIG. 4, an in-flight instruction is generally an instruction between execution (402) and commit (408) stages, e.g., as determined by an instruction issue queue (204 of FIG. 2).

In an embodiment of the invention, after a check instruction is issued (501), the ALAT buffer (212) is searched (502), e.g., by utilizing the physical register identifier (REG) 304 of the ALAT buffer 212 of FIG. 3. If one or more matches are found (504), it is determined whether the youngest match (e.g., as determined by the instruction identifier (IID) 308 of the ALAT buffer 212 of FIG. 3) is a deallocation or allocation event (506). If the youngest matching entry in the ALAT buffer 212 corresponds to a deallocation event (506) (e.g., as indicated by the field 302 of the ALAT buffer 212 in FIG. 3), the check will fail. If, instead, the youngest matching entry in the ALAT buffer 212 corresponds to an allocation event, the check will succeed.

If a matching entry in the ALAT buffer 212 is absent, as determined by the stage 504, the ALAT (210) is searched (508), e.g., by utilizing the physical register identifier (REG) 304 of the ALAT 210 of FIG. 3. The check will succeed if there is a matching entry present in the ALAT (510). Otherwise, if a match is absent, the check will fail.

Accordingly, in one embodiment of the invention, when performing a check instruction, the contents of younger entries of the ALAT buffer 212 take precedence over older entries from the perspective of the younger ALAT checks. Additionally, the ALAT buffer 212 entries may take precedence over the ALAT 210 entries.

In some embodiments of the invention, in-flight store (and semaphore) instructions are not stored in the ALAT buffer 212. Their side effect, architecturally, is to invalidate ALAT 210 entries with the same physical address. However, subsequent ALAT 210 checks may perform their search of the ALAT 210 by physical register identifier, so an in-flight store may not be readily related to a check other than through its invalidation of an existing entry. In an embodiment of the invention, in-flight stores may be allowed to invalidate both ALAT 210 entries with matching physical address, as well as convert ALAT buffer 212 entries with matching physical address from allocation events into deallocation events. Furthermore, in an embodiment of the invention, the set of physical register identifiers may be compiled into a list whose associated physical address matches the store instruction, and the list may be associated with the store instruction and stored in the ALAT buffer 212. Subsequent checks for any of those physical register identifiers may match that entry in the ALAT buffer 212 and fail.

In one embodiment of the invention, an optimization may be made to avoid considering the age order (e.g., as indicated by the field 308 of FIG. 3) of the set of ALAT buffer 212 entries that match a check instruction. In particular, if that set of matches contains multiple entries, and either all are allocation or all are deallocation events, the result may still be known (i.e., success or failure, respectively). However, if there is a mix of allocation and deallocation events in the matched set, the check instruction may be retried at a later time, e.g., when one or more of the entries in the set of matches is committed, leaving one or fewer results and resolving the ambiguity.

In various embodiments of the invention, the operations discussed herein, e.g., with reference to FIGS. 1-5, may be implemented as logic and/or software (e.g., a software compiler) that is provided as a computer program product, which may include a machine-readable or computer-readable medium having stored thereon instructions used to program a computer to perform a process discussed herein. The machine-readable medium may include any suitable storage device such as those discussed with respect to FIGS. 1A and 1B.

Additionally, the such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment of the invention” or “an embodiment of the invention” means that a particular feature, structure, or characteristic described in connection with the embodiment of the invention is included in at least an implementation. The appearances of the phrase “in one embodiment of the invention” in various places in the specification may or may not be all referring to the same embodiment of the invention.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method comprising:
storing information corresponding to an uncommitted data speculative instruction in an advanced load address table buffer prior to storing the information in an advanced load address table.

2. The method of claim 1, further comprising storing the information in the advanced load address table after the data speculative instruction is committed.

3. The method of claim 1, further comprising removing one or more entries corresponding to the data speculative instruction from the advanced load address table buffer after the data speculative instruction is committed.

4. The method of claim 1, wherein storing information corresponding to the data speculative instruction comprises storing information in a plurality of entries of the advanced load address table buffer, the plurality of entries potentially corresponding to a same physical register identifier.

5. The method of claim 4, further comprising utilizing the plurality of entries to unwind an aborted data speculative instruction.

6. The method of claim 1, wherein storing information corresponding to the data speculative instruction stores one or more items in an entry of the advanced load address table buffer, the one or more items being capable of modifying an interpretation of a physical register identifier corresponding to the data speculative instruction.

7. The method of claim 1, wherein storing information corresponding to the data speculative instruction is performed after issuing the data speculative instruction.

8. The method of claim 1, further comprising deallocating one or more entries of the advanced load address table buffer when the data speculative instruction is aborted, wherein the one or more entries correspond to one or more of the data speculative instruction and a younger data speculative instruction.

9. The method of claim 1, wherein the data speculative instruction performs one or more tasks selected from a group comprising at least an advanced load, a check load, and an advanced load address table invalidation.

10. The method of claim 1, further comprising searching the advanced load address table buffer prior to the advanced load address table to find a match for an uncommitted data speculative instruction capable of modifying the advanced load address table.

11. The method of claim 10, further comprising indicating a check instruction success after searching the advanced load address table buffer if a youngest match in the advanced load address table buffer corresponds to an allocation event.

12. The method of claim 10, further comprising indicating a check instruction failure after searching the advanced load address table buffer if a youngest match in the advanced load address table buffer corresponds to a deallocation event.

13. The method of claim 10, further comprising searching the advanced load address table if a match for the uncommitted data speculative instruction is absent from the advanced load address table buffer.

14. The method of claim 13, further comprising indicating a check instruction failure after searching the advanced load address table if a match in the advanced load address table is absent.

15. The method of claim 13, further comprising indicating a check instruction success after searching the advanced load address table if a match in the advanced load address table is present.

16. An apparatus comprising:
an advanced load address table buffer to store information corresponding to an uncommitted data speculative instruction prior to storing the information in an advanced load address table.

17. The apparatus of claim 16, further comprising a data translation buffer coupled to the advanced load address table buffer to provide a physical address corresponding to the data speculative instruction.

18. The apparatus of claim 16, further comprising an instruction issue queue to perform one or more tasks selected from a group comprising scheduling and issuing an instruction to one or more components of a processor core that comprises the advanced load address table and advanced load address table buffer.

19. The apparatus of claim 16, wherein the information corresponding to the data speculative instruction comprises one or more items in an entry of the advanced load address table buffer, the one or more items being selected from a group comprising an allocate field, a physical register identifier, a physical address, an instruction identifier, a retired field, an occupied field, an invalidate all field, and an invalidate frame field.

20. A processor comprising:
means for executing instructions;
means for issuing the instructions for execution; and
means for storing information corresponding to an uncommitted data speculative instruction prior to storing the information in an advanced load address table.

21. The processor claim 20, further comprising means for searching the means for storing information prior to the advanced load address table.

22. The processor of claim 20, further comprising means for deallocating one or more entries of the means for storing information corresponding to the data speculative instruction when the data speculative instruction is aborted.

23. A system comprising:
a memory to store instructions; and
a processor with an advanced load address table buffer to store information corresponding to an uncommitted data speculative instruction prior to storing the information in an advanced load address table.

24. The system of claim 23, further comprising an audio device.

25. The system of claim 23, wherein the memory is one or more of a hard drive, RAM, DRAM, and SDRAM.

26. The system of claim 23, further comprising a data translation buffer coupled to the advanced load address table buffer to provide a physical address corresponding to the data speculative instruction.

27. The system of claim 26, wherein a memory execution unit of the processor comprises one or more of the data translation buffer, the advanced load address table buffer, and the advanced load address table.

28. The system of claim 23, further comprising an instruction issue queue to perform one or more tasks comprising scheduling or issuing an instruction to one or more components of the processor.

29. The system of claim 23, wherein the processor comprises the advanced load address table.

30. The system of claim 23, wherein the information corresponding to the data speculative instruction comprises one or more items in an entry of the advanced load address table buffer, the one or more items being selected from a group comprising an allocate field, a physical register identifier, a physical address, an instruction identifier, a retired field, an occupied field, an invalidate all field, and an invalidate frame field.
